(19) United States
(12) Patent Application Publication
(10) Pub. No.: US 2023/0419325 A1
(43) Pub. Date: Dec. 28, 2023

(54) METHOD FOR PROCESSING AN OPERATION INVOLVING SECRET DATA, TERMINAL, SYSTEM AND CORRESPONDING COMPUTER PROGRAM

(71) Applicant: BANKS AND ACQUIRERS INTERNATIONAL HOLDING, Suresnes (FR)

(72) Inventors: Nicolas CHRUPALLA, Andrésy (FR); Nabil HAMZI, Cugy VD (CH)

(73) Assignee: BANKS AND ACQUIRERS INTERNATIONAL HOLDING, Suresnes (FR)

(21) Appl. No.: 18/254,642

(22) PCT Filed: Nov. 29, 2021
(86) PCT No.: PCT/EP2021/083425

§ 371 Date: May 26, 2023

(30) Foreign Application Priority Data
Nov. 30, 2020 (FR) 2012428

(51) Int. Cl. G06Q 20/40; G06F 21/36

(52) U.S. Cl. CPC G06Q 20/4014; G06F 21/36; G06Q 20/4012

(57) ABSTRACT

A method for processing data from an input on a touch screen of an electronic terminal including an intermediate transactional server connection module, said method including: —receiving a random variable, from the intermediate transactional server via a secure link; —receiving, from a touch panel controller, coordinates of pressure on the touch panel; —transforming, via a transformation function fTs, the coordinates of pressure on the touch panel using the at least one datum representative of a random variable, thereby delivering a random character datum; —transmitting the datum representative of a random character to a verification terminal.

### 1. TECHNICAL FIELD

The disclosure relates to the field of the computer security. More specifically, the disclosure relates to the security and confidentiality of data processing within a communication terminal, such as a smartphone or a terminal processing sensitive data equipped with a touch screen.

### 2. PRIOR ART

Since the massive adoption of intelligent communication terminals (smartphone) by a large part of the population, the idea was born of being able to make a payment via such a terminal. The more recent appearance on these terminals of contactless means of communication (NFC-type communication interface) has made it possible to seriously consider the implementation of payment transactions directly on these terminals. The general principle that was initially considered consisted in using a contactless payment card that the user affixes to his communication terminal. A specific application, installed on the communication terminal and secure, is supposed to obtain the necessary data from the user's bank card and use this data to carry out the payment transaction. Quickly, the need to secure such a transaction appeared, in particular to ensure that the generated transaction is considered as a “card present” transaction, guaranteeing greater security of the payment transaction. Yet, to deliver a “card present” transaction, the user's bank card must play an “active” role in the transaction, this role not being limited to a simple provision, contactless, of payment data (number, name, date, validation code). Thus, the need to enter a PIN (“Personal Identification Number”) code on the touch screen of the communication terminal appeared. The use of this PIN code entered by the user for the implementation of the transaction is similar to the use of this same PIN code on a “classic” payment terminal (i.e. with a smart card). Manufacturers have therefore started work to be able to implement such PIN code entries on the touch screen. Quickly, in parallel, it appeared that it was not necessary to use a payment card physically affixed to the terminal to carry out transactions. The principle of “Card On File” thus appeared, in particular for high-end communications terminals, which had more advanced security functions (presence in particular of a “Trusted Execution Environment”—TEE-) to be able to transmit payment data. It should also be noted that these payment data can theoretically be transmitted online (i.e. via the use of a merchant application on the user's communication terminal) and contactless (by placing the communication terminal of the user on a merchant's physical payment terminal). Nevertheless, and despite the advances in terms of security for the processing of these banking data by the communication terminal (with touch screen), the need to be able to enter a PIN code relating to banking data persists, because it is an additional guarantee of security. This need for entering a PIN code has also evolved over time, going from a need rather linked to an entry on a communication terminal of a user, to a need linked to entering a PIN code on the touch screen on many types of terminals, which it would be practical to be able to use in complete safety in order to be able to enter the PIN code.

In the context of the present, we are interested, for example, in the entry of secret information on a touch screen terminal (of the communication terminal type), in the context of a payment transaction carried out with a payment terminal (whether it is a physical terminal, at a merchant's, or a remote terminal, for example installed on a processing server implementing a payment terminal). In this configuration, the user of the communication terminal therefore uses this terminal to enter the secret information, which is then transmitted to the payment terminal (physical or remote), which validates the conformity of the secret information. In other words, one splits, in two different devices (including a touch screen terminal, not necessarily secure and a “secure” verification terminal), an operation (the entry of secret information) which until then was carried out on a single device: only a secure terminal.

These contextual considerations being exposed, in a concrete way, the entry of the keys of the PIN code is carried out on a virtual keyboard of the touch screen. The virtual keyboard takes the form of a keyboard displayed by a (secure) application that runs on the touch screen terminal.

A first method envisaged by the inventors consisted in the transformation of the “touch events” of the virtual keyboard into (numerical) characters directly on the application of the touch screen terminal, via a principle of obfuscation. Despite these protective measures, this method did not withstand inspection by the laboratory in charge of the security evaluation of the application. One of the characteristics of the problem that the inventors have to face is that the application in charge of managing the entry of the PIN code runs on an “open” terminal. The “open” terminal is qualified as such because it is managed by a user, who can install software applications of his choice on it. This possibility is offered by the publisher of the operating device of the open terminal (such as Android™ or iOS™ for example). Insofar as it is admitted that these freely installable applications are not secure (that is to say they may comprise all or part of the fraudulent modules) or that the user himself may endanger the security of the open terminal by having unsuitable behavior, the open terminal is by nature considered as unsecured, and therefore as potentially presenting risks for the operation of an application which manages confidential data, such as payment data.

Thus, during the evaluation of the security of such an application, the evaluator has at his disposal the control of the entire touch screen terminal on which the application which manages the entry of the PIN code is installed.

A first method of solving the control problem posed by the evaluator would consist in having, within the “secure” verification terminal, a table for transforming the “touch events” into characters. The disadvantage of this method is that it relies on a secret that is embedded in the application of the verification terminal, and therefore also attackable by a fraudster (or an evaluator), although such an operation is more complex.

Thus, despite the theoretical possibility of using a touch screen terminal to implement a secure entry of secret information, this possibility proves, in practice, not to be implemented.

### 3. SUMMARY OF THE INVENTION

The disclosure makes it possible to respond at least in part to the problems posed by the prior art. More particularly, the disclosure relates to a method for processing data resulting from an entry on a touch screen, method implemented within an electronic terminal comprising a touch screen on which the data is entered, said electronic terminal comprising an intermediary transactional server connection module.

Such a method comprises:
a step of receiving, from the intermediate transactional server to which the touch screen terminal is connected via a secure link, at least one data representative of a random variable;
a step of receiving, from a touch panel controller, data representative of coordinates (x,y) of pressing on the touch panel of the terminal;
a step of transforming, via a transformation function ƒ_{Ts}, said data representative of coordinates (x,y) of pressing on the touch panel of the terminal, using one of said at least one data representative of a random variable, delivering data representative of a random character, such that data representative of a different random variable (Dra, ParT) is used for each press on the touch panel of the terminal;
a step of transmitting the data representative of a random character to a verification terminal.

Thus, the disclosure offers the possibility of managing in a secure manner, the entry of confidential data on an entry terminal which may be compromised, because the character conversion data are not available to the electronic terminal, which does not possess, at a given time, one or several random variables that are used to modify the output of the keystroke transformation function. The touch screen terminal therefore does not have any information at its disposal enabling it to find the confidential code that the user wished to enter.

According to a particular characteristic, the transformation step comprises the application of the following transformation function:

Cₛₐ=ƒ_{Ts}(R,x,y,a) [Math1]
Cₛₐ is an obtained random character, which is transmitted in the form of the data representative of a random character;
R is a screen resolution;
x is the abscissa of the data representative of coordinates (x,y);
y is the ordinate of the data representative of coordinates (x,y);
a is a random variable inserted in the calculation, a random variable obtained from said at least one data representative of a random variable;

Thus, it is not possible, even with knowledge of the function, to determine its result, since this result depends on a random variable transmitted, online, or even in real time, by the intermediary transactional server.

According to a particular characteristic, the transformation function implements a random permutation, generated by the intermediate transactional server and received at least in part by the electronic terminal.

According to a particular characteristic, the transformation function implements a module function, the parameters of which have been randomly determined by the intermediate transactional server and received at least in part by the electronic terminal.

According to a particular characteristic, the processing method further comprises, prior to the step of receiving said at least one data representative of a random variable, an optional step of transmitting, to the intermediate transactional server, data representing a screen resolution of the touch screen of the electronic terminal.

According to a particular characteristic, the processing method is implemented during the execution of an electronic payment transaction involving the entry, by a user, of a personal identification code on the touch screen of the electronic terminal.

According to another aspect, the invention also relates to an electronic terminal comprising a touch screen on which data is entered, said electronic terminal comprising an intermediary transactional server connection module. Such a terminal comprises:
a module for receiving, from the intermediate transactional server to which the touch screen terminal is connected via a secure link, at least one data representative of a random variable;
a module for receiving, from a touch panel controller, data representing coordinates (x,y) of pressing on the touch panel of the terminal;
a transformation module, via a transformation function ƒ_{Ts}, of said data representative of coordinates (x,y) of pressing on the touch panel of the terminal, using said at least one representative data of a random variable, delivering data representative of a random character;
a module for transmitting the data representative of a random character to the intermediate transactional server.

According to another aspect, the disclosure also relates to an intermediate transactional server, a server of the type comprising a central unit, a memory and a module for receiving and transmitting data from a communication network. Such a server comprises:
a module for determining data representative of a resolution of a touch screen of an electronic terminal on which data must be entered;
a module for generating at least one data representative of a random variable, optionally depending on the data representing a screen resolution of the touch screen of the electronic terminal;
a module for transmitting said at least one data representative of a random variable to the electronic terminal, and
a module for transmitting, to a verification terminal, a table for decoding characters entered on said touch screen of the electronic terminal.

According to another aspect, the disclosure also relates to a terminal for verifying the validity of data entered on a touch screen of a touch screen terminal, terminal of the type comprising a central unit, a memory and a module for receiving and transmitting data from a communication network.

Such a terminal comprises:
a module for receiving, from an intermediate transactional server, a table for decoding characters entered on said touch screen of the electronic terminal;
a module for receiving, from the electronic terminal comprising a touch screen, data representative of a random character obtained by the execution of a transformation function ƒ_{Ts}, data representative of coordinates (x,y) of pressing on the touch panel of the terminal, with at least one data representative of a random variable;
a module for converting the data representative of random characters into characters actually entered;
a module for validating the characters actually entered for validating a transaction.

According to another aspect, the disclosure also relates to a system for processing data resulting from an entry on a touch screen, the system comprising an electronic terminal, an intermediate transaction server and a verification terminal according to the claim as described above.

According to a preferred implementation, the various steps of the methods according to the present disclosure are implemented by one or several software or computer programs, comprising software instructions intended to be executed by a data processor of an execution terminal according to the present technique and being designed to control the execution of the various steps of the methods, implemented at the level of the communication terminal, the electronic execution terminal and/or the remote server, within the framework of a distribution of the processing operations to perform and determined by a script source code or compiled code.

Consequently, the present technique also aims at programs capable of being executed by a computer or by a data processor, these programs including instructions for controlling the execution of the steps of the methods as mentioned above.

A program may use any programming language, and be in the form of source code, object code, or intermediate code between source code and object code, such as in partially compiled form, or in any other desirable form.

The present technique also aims at an information medium readable by a data processor, and including instructions of a program as mentioned above.

The information medium can be any entity or terminal capable of storing the program. For example, the medium may include a storage medium, such as a ROM, for example a CD ROM or a microelectronic circuit ROM, or else a magnetic recording medium, for example a mobile medium (memory card) or a hard drive or SSD.

On the other hand, the information medium can be a transmissible medium such as an electrical or optical signal, which can be conveyed via an electrical or optical cable, by radio or by other means. The program according to the present technique can in particular be downloaded from a network of the Internet type.

Alternatively, the information medium may be an integrated circuit in which the program is incorporated, the circuit being adapted to execute or to be used in the execution of the method in question.

According to one embodiment, the present technique is implemented by means of software and/or hardware components. From this perspective, the term “module” may correspond in this document to a software component, a hardware component or a set of hardware and software components.

A software component corresponds to one or several computer programs, one or several sub-programs of a program, or more generally to any element of a program or software capable of implementing a function or a set of functions, as described below for the concerned module. Such a software component is executed by a data processor of a physical entity (terminal, server, gateway, set-top-box, router, etc.) and is likely to access the hardware resources of this physical entity (memories, recording media, communication bus, electronic input/output cards, user interfaces, etc.).

In the same way, a hardware component corresponds to any element of a hardware assembly able to implement a function or a set of functions, according to what is described below for the concerned module. It can be a hardware component that can be programmed or has an integrated processor for executing software, for example an integrated circuit, a smart card, a memory card, an electronic card for executing a firmware, etc.

Each component of the system described above naturally implements its own software modules.

The different embodiments mentioned above can be combined with each other for the implementation of the present technique.

### 4. BRIEF DESCRIPTION OF DRAWINGS

Other characteristics and advantages will appear more clearly on reading the following description of a preferred embodiment, given by way of a simple illustrative and non-limiting example, and the appended drawings, among which:

FIG. 1 exposes the general principle of the method for processing data entered on a touch screen according to this technique;

FIG. 2 exposes a method for processing payment transaction in which the method of FIG. 1 is implemented;

FIG. 3 is a schematic representation of a touch screen terminal for implementing the data processing method previously presented;

FIG. 4 is a schematic representation of an intermediate transactional server for implementing the data processing method presented above.

### 5. DETAILED DESCRIPTION

The general principle of this technique is based on the implementation of a secret function, this function not being in possession of the communication terminal which is used to enter the personal identification code. More particularly, the virtual keyboard is displayed on the communication terminal. This virtual keyboard displays the numbers and/or characters to be used to enter the secret information held by the user (personal identification code, password, etc.). The displayed virtual keyboard can be a standard keyboard, adapted according to the user's language and country (the keyboard is then immediately recognized by the user). However, according to the present technique, the virtual keyboard is a keyboard specifically dedicated to entering the data required by the secure processing to be implemented. In this case, the keyboard is generated by the application requesting the secure entry. The keyboard can be displayed randomly. In other words, the keyboard keys are not necessarily displayed in the standard order. The keys can be shuffled so as to produce a random display of these keys on the entry touch screen. This makes entry more complicated for the user, but prevents a fraudulent or malicious program from inferring keystrokes based on events other than entry events.

Whatever display is made, the computer program in charge requires the user's information to be entered. According to this technique, to prevent the entered information from being intercepted by a malicious program, a secret function is implemented within the legitimate program, to deliver a random character resulting from the input made by the user.

In a non-secure version, as previously presented, the data entry program on the touch screen transforms a press on the touch screen into {x; y} coordinates, the reference point of the screen being traditionally the upper left corner (which represents the coordinates {0; 0}). A transformation function ƒ_{Tns} is then used, within the program, to transform these coordinates {x; y} into an entered character. In particular, the ƒ_{Tns} transformation function takes into account the resolution of the terminal's touch screen and transforms the made entry:

[Math2]

Cₛ=ƒ_{Tns}(R,x,y) (1)

In which
C s is the entered character (recognized);
R is the screen resolution;
x is the abscissa;
y is the ordinate.

In this basic version, massively implemented on entry terminals at present, the function ƒTns performs a transformation {x;y} into an index to know the location of the press on the virtual keyboard. Such a function is for example implemented by Google™ Gboard™ or Apple™ keyboards.

As explained above, this type of non-secure function is not really usable for entering sensitive information.

The inventors therefore had the idea of proposing a new function so that it integrates a new parameter: it is a random parameter (a). This random number (a) is introduced each time the key is pressed and is used to modify the result of the calculation of the function. The new function ƒ_{Ts} is therefore:

[Math3]

Cₛₐ=ƒ_{Ts}(R,x,y,a) (2)
Cₛₐ is the obtained random character;
R is the screen resolution;
x is the abscissa;
y is the ordinate;
a is the random number inserted in the calculation.

According to this technique, the random variable is not determined by the touch screen terminal. Indeed, we are trying to protect ourselves from a fraudulent program that would be installed on this terminal. It is therefore assumed that this touch screen terminal is corrupted and therefore the principle that its resources are potentially under the control of this fraudulent program (resources of which the random or pseudo-random generator of the terminal may form part). This random variable is also not determined by the “secure” verification terminal to which the entered information is transmitted for validation of conformity, because this terminal could itself potentially be under the control of a fraudulent application. Consequently, in order to guard against this type of threat, the random variable (a) is received from a server to which the touch screen terminal is connected. More specifically, the random variable is received from a server which may be in charge of the joint implementation of the transaction with the touch screen terminal and/or the verification terminal. This server is called an intermediate transactional server.

Thus, the described technique is partially part of the implementation of a system comprising an intermediate transactional server, a “secure” verification terminal (which can take the form of a physical terminal or a remote terminal (i.e. “virtual”) and the touch screen terminal in the possession of the user, terminal which is in charge of obtaining personal and confidential data held by the user (i.e. personal identification code, password). Note that these data are not “saved” on the touch screen terminal. In essence, these data are intended to implement a transaction requiring identification or authentication: they are therefore not in the possession of the touch screen terminal of the user and it is not envisaged that this data be recorded by the terminal to facilitate the use of the latter (it is not a question, for example, of letting the touch screen terminal take over to save this data in a secured way within the terminal). Remember that the terminal is believed to be corrupted, so it is best to avoid saving this type of data there. The operation of the present technique consists in inserting a random number into the calculation function of the characters which are entered on the keyboard displayed on the touch screen terminal. To do this, the random number is determined by an intermediate transactional server, and a different random number is potentially used for each key press on the touch screen. The intermediate transactional server can transmit the random numbers in the form of a random list [a₁, a₂, a₃, a₄, a₅, . . . aₙ], during the initialization of the transaction with the touch screen terminal. The intermediate server can also transmit a random number after each key press, according to a method in which the first random number is transmitted by the intermediate server; then the user presses the touch screen; the terminal determines a character using the function ƒ_{Ts}; the terminal transmits the result obtained by the function ƒ_{Ts} to the verification terminal; upon receipt of this result, of which it is informed by the verification terminal or directly by the touch screen terminal, the intermediate server generates a new random number and transmits it to the touch screen terminal, etc. Regardless of how the random variables are transmitted to the touch screen terminal, according to the present technique, the validation character, which is used to signify the end of entry by the user (this is generally the character “enter” (“return”) or an “OK” key), is not treated differently from other characters on the keyboard. A random variable is also used for this validation character or function. This characteristic is important because it ensures that a malicious application installed on the touch screen terminal cannot guess or infer when password entry is complete, even if that malicious application succeeds in intercepting the characters generated by the function ƒ_{Ts}. Thus, the malicious application cannot guess for example the length of the password. According to the present technique, the display of the keyboard on the touch screen terminal is managed at least partially by the intermediate server. It is the intermediate server (or the verification terminal) that instructs the computer program for entering the password on the touch screen terminal to close the keyboard for entering the password or the PIN. To do this, the input computer program receives, from the intermediate server (or the verification terminal), a closing instruction encapsulated in a message. This makes it possible to limit or even eliminate the risks of a malicious application taking control of the data entry computer program.

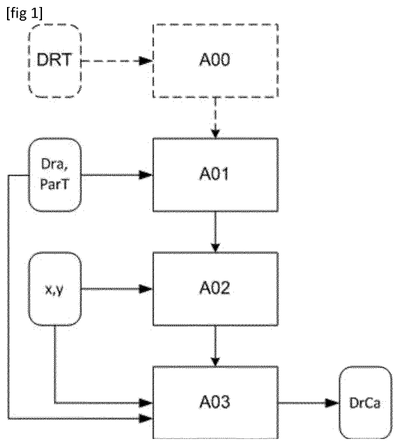

Concretely, the transaction management application, when it is started, transmits to the intermediate server the resolution of the screen on which it is running (or any other information allowing the server to determine this resolution, such as an identifier of the touch screen terminal, identifier that allows the intermediate server to find the resolution of the touch screen of the terminal). Depending on this resolution, the server determines a random correspondence between the key events (x,y) and the corresponding character. FIG. 1 explains the different steps of the processing method according to the present technique. Such a processing method comprises:
an optional step of transmitting (A00), to a transactional server, data (DRT) representative of a screen resolution of the touch screen of the touch screen terminal; this representative data may actually be a screen resolution, a terminal identifier allowing to obtain such a resolution, from data available from the transactional server, or even an application identifier allowing to obtain such data; this step is not mandatory, because depending on embodiments, it is not necessary to have such a resolution to implement the described technique;
a step of receiving (A01), from the intermediate transactional server (Sti) to which the touch screen terminal (TermEt) is connected via a secure link, at least one data representative of a random variable (Dra, ParT), optionally depending on the data (DRT) representative of a screen resolution of the touch screen of the touch screen terminal;
a step of receiving (A02), from a touch panel controller (CtrIDT), data representative of coordinates (x,y) of pressing on the touch panel of the terminal; this is for example a press made with a finger from a user entering a password or a personal identification code;
a step of transforming (A03), via the transformation function ƒ_{Ts}, said data representative of coordinates (x,y) of pressing on the touch panel of the terminal, by means of said at least one data representative of a random variable (Dra, ParT), delivering data representative of a random character (DrCa);
a step of transmitting (A04), data representative of a random character (DrCa) to the verification terminal.

In one exemplary embodiment, the implementation of the random variable is implemented by a random permutation. A random permutation is drawn, by the intermediate server, and each character is chosen as part of that chosen permutation. The intermediate server transforms this function into a table and transmits it to the verification terminal, for example when initializing the transaction (that is to say after establishing the secure link with the intermediate server). The intermediate server then transmits to the application the “random variable” (a) which allows selecting the permutation in the permutation table. A different permutation table may be transmitted for each entered character. A random variable (a) may also be transmitted to each entered character. The random variable is therefore variable. Several methods for varying this random variable with each key press are possible. Two distinct variants may be implemented in the case of the random permutation: the first variant consists in performing a random permutation of characters, directly from the characters of the keyboard, for example a “qwerty” keyboard will have a “rteywq” permutation (deliberately limited example) or a “1234567890” keyboard will have a “8463917205” permutation; the second variant consists in performing, from the beginning, a random permutation of the key presses (coordinates x,y); which is more efficient in terms of security, but also more voluminous in terms of data to be transmitted.

In another exemplary embodiment, the implementation of the random variable is implemented by a technique of random variable draw and application of a module (that is to say application of a module on the obtained number), the module being also random. More specifically, the module (modulo) is randomly obtained by the intermediate server (for example “34”) and a random variable (for example “29”) is also determined randomly within the interval between 1 and the random module (here “34”). In such a case, there are two random variables: the module Mᵢ and the random variable in the module a_{M}. They are transmitted to the application in charge of the entry on the touch screen terminal. Going back to the previous example: the user presses the key with the character “c” of value “9”: the obfuscated function ƒ_{Ts} calculates (c+a_{M}) modulo Mᵢ, that is to say (9+29).mod(34)=4 and transmits 4 to the verification terminal. For the next character, a new module and a new random variable are used. The modules, as in the previous case of the random permutation, may be transmitted in advance (like the permutation table) or one module may be transmitted for each character. The advantage of this second example of implementation, compared to the first, is to be able to transmit two short random variables, for each character, which is not necessarily possible with the random permutation, particularly when the keyboard is extended (case of a full “azerty” or “qwerty” type keyboard for entering a password, for example). In another exemplary embodiment, both the technique of the random permutation and the technique of the module are used. This may for example be the case for a keyboard of numeric characters (ten characters from [0] to [9]) and two function keys (“Cancellation”, “Validation”), i.e. twelve keys in total. In this situation the obfuscated function ƒ_{Ts} allows from a key press event {x;y} to generate a random index. This goes through a first step that transforms the key press into an index comprised between zero and twelve. With these twelve characters, modulo 13 (prime number) may be calculated, permutations may be generated quite easily thanks to this number.

A permutation is generated: the function ƒ_{Ts}, is a random permutation which is composed of an affine transformation based on two random numbers which are drawn from the random variable, and they are used “modulo 13”. With this modulo 13, any random function creates a permutation. We therefore get to permute with only two numbers all the characters of the keyboard and we simply obtain a random permutation. In the case where a simple random permutation of the entire keyboard is generated, for each key press, it is possible to compress the data transmitted to the terminal so as not to unnecessarily limit the responsiveness of the terminal used for entering. Moreover, all of the random permutations (or parameters) may be transmitted in one block before the actual start of entry on the touch screen terminal.

As explained above, the random variable comes from the intermediate transactional server. The server knows the function ƒ_{Ts} so it is able to calculate the correspondence and provide an inverse conversion table to the verification terminal. Consequently, the verification terminal also does not have the logic since it does not implement a function (for example the affine function modulo 13). It only implements an access to one or several tables, which come from the server and which is modified with each PIN entry, and/or with each character entry. Thus, even if an attacker masters the software of the verification terminal, the only information that will be obtained is an access to a table, not recorded in this software.

The communication terminal implements the logic for entering the key and transmitting the entered random characters to the verification terminal. It implements it thanks to the random variable (or random variables) that comes from the intermediate transactional server and optionally, for an increased security, thanks to obfuscation methods (thus, this function ƒ_{Ts} which transforms a key press into a character is completely obfuscated). The obfuscation makes it very difficult to perform reverse engineer and understand the implemented method.

The function ƒ_{Ts} is embedded in or accessible for the mobile application in an obfuscated form (very difficult to understand). Either this function is available, in the form of an API, from the application, or this function is directly integrated into the application itself. Ideally, this function is implemented within a secure execution element of the touch screen terminal (“secure element”) or a trusted execution environment (“TEE”), in order to further protect against attempts of frauds. Such an implementation is described later, although it is not mandatory to guarantee the primary effect of securing obtained by the obfuscated function ƒ_{Ts}.

Whatever the mode of implementation of the random variables, each time the virtual keyboard of the application is pressed, the random character is generated by the obfuscated function ƒ_{Ts} embedded or accessible for the mobile application.

Each time a password or character is entered, a new correspondence table may be calculated, thus allowing to effectively protect the entered password (with a notable increase in efficiency for a change of random variable or parameter at each character).

For example, at the first character entry, the user wishes to enter the key ‘1’. This key corresponds, after transformation by the obfuscated function ƒ_{Ts}, to the random character ‘6’.

The mobile application transmits, via the secure transmission channel, the number ‘6’ to the verification terminal, which by applying the inverse function ƒ_{Ts}⁻¹ transforms the entry back into ‘1’ (that is to say by using the table received from the intermediate server). During the next press, if the user wishes to press the key ‘1’ again, a new corresponding key ‘9’ is obtained by the obfuscated function ƒ_{Ts}. The verification terminal, by applying the inverse transformation ƒ_{Ts}⁻¹ again, obtains a ‘1’ (by simply accessing an inverse permutation table transmitted by the intermediate transactional server).

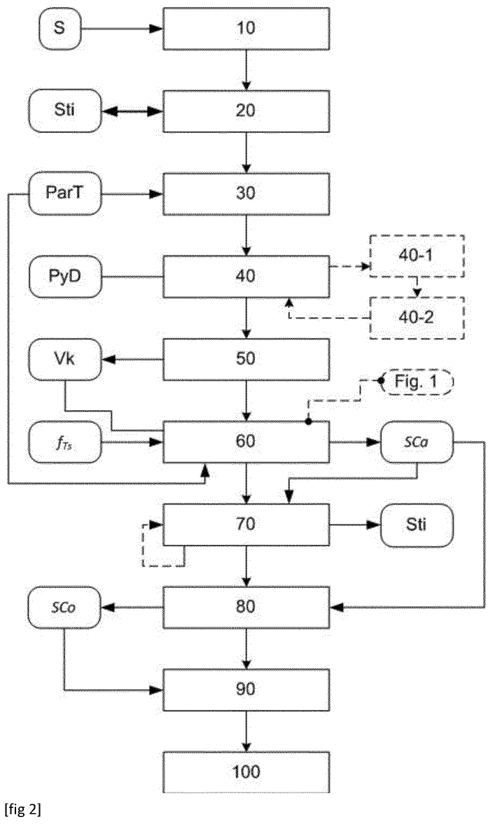

There is described, in relation to FIG. 2, a method for implementing a financial transaction, using a touch screen terminal, requiring, for the implementation of this transaction, in particular the obtaining of payment data from a means of payment presented by a user (the example of a contactless payment card is used). In the method presented in FIG. 2, the function ƒ_{Ts} is implemented for entering a PIN code in conjunction with obtaining data from the contactless card. It should be noted that the method may also be implemented with a contact card (conventional payment terminal having a touch screen for entering the PIN code) or for a payment made via a communication terminal of a user (with or without use of a payment card, the payment data may already be recorded within the mobile terminal, that is to say in the form of a “card on file”). Such a method comprises:
a step (10) of starting the transaction
a step of establishing (20), with the intermediate transactional server, a secure communication link;
a step of receiving (30), from the intermediate transactional server, the configuration data of the transaction (ParT), including the random variable(s) (Dra) and its parameters;
a step of obtaining (40) payment data (PyD), comprising for example:
a step of displaying (40-1), on the screen of the screen terminal, a request to affix a payment card to the touch screen terminal;
a step of reading (40-2) the data from the payment card affixed to the touch screen terminal;
a step of displaying (50) a virtual keyboard (Vk) requiring the entry of a personal identification code;
a step of entering (60), by the user, a plurality of digits of the personal identification code, on the virtual keyboard (Vk), comprising the use, for each entered digit, of the function ƒ_{Ts} and data of the configuration (ParT) of the transaction delivering a series (SCa) of random digits;
a step of transmitting (70), to the verification terminal, via the secure channel (or another channel), the series of random digits (SCa); the transmission step is either implemented once, for the entire series, or implemented as soon as a digit is entered by the user;
a step of decoding (80), by the verification terminal, the series of random digits (SCa), delivering a series of original digits (SCo);
a step of validating (90) the transaction by the verification terminal;
a step of transmitting (100) the validation result of the transaction to the touch screen terminal and a step of displaying, by the touch screen terminal, this result.

Thus, even if the touch screen terminal is infected or compromised, it is not possible to intercept and correctly understand what are the actual digits entered by the user for the PIN code, because these digits are randomly generated by the transformation function when entering them.

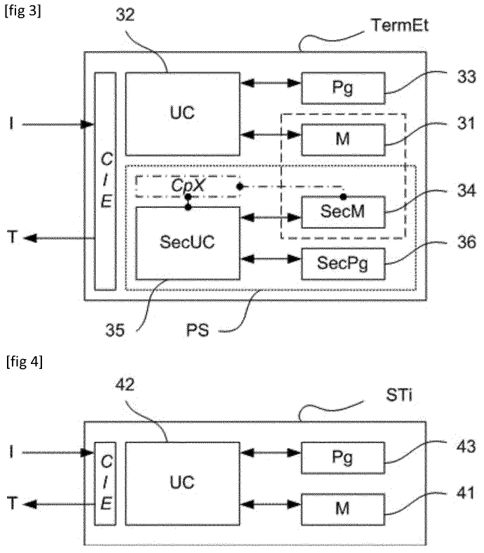

In relation to FIG. 3, a simplified architecture of a touch screen terminal (TermEt) capable of performing the processing of a transaction as presented above is presented. A touch screen terminal comprises a memory 31, a processing unit 32 equipped for example with a microprocessor, and driven by a computer program 33. The touch screen terminal optionally comprises: a secure memory 34, which may be merged with the memory 31 (as indicated in dotted lines, in this case the memory 31 is a secure memory), a secure processing unit 35 equipped for example with a secure microprocessor for physical protection measures (physical protection around the chip, by mesh, vias, etc. and protection on the data transmission interfaces), and driven by a computer program 36 specifically dedicated to this secure processing unit 35, this computer program 36 implementing all or part of the method for processing a transaction as previously described. The group composed of the secure processing unit 35, the secure memory 34 and the dedicated computer program 36 constitutes the secure portion (PS) of the touch screen terminal. In at least one embodiment, the present technique is implemented in the form of a set of programs installed in part or in whole on this secure portion of the transaction processing terminal. In at least one other embodiment, the present technique is implemented in the form of a dedicated component (CpX) capable of processing data of the processing units and installed in part or in whole on the secure portion of the transaction processing terminal. Furthermore, the terminal also comprises a communication module (CIE) being for example in the form of network components (WiFi, 3G/4G/5G, wired) which allow the terminal to receive data (I) from entities connected to one or several communication networks and transmit processed data (T) to such entities.

Such a terminal comprises, depending on the embodiments:
a module for obtaining data from presented transactional devices of the users (access card, transaction card, etc.; these means may be, for example, in the form of a smart card reader, or even NFC-type or RFID-type contactless card readers);
a module for obtaining random variables and configuring random variables from an intermediate transactional server;
an entry module, allowing the user to enter one or several data for the implementation of the transaction, when necessary (in particular a module for generating a keyboard on a touch screen)
a module for processing the data obtained by the means for obtaining data from the transactional devices and a module for processing the data entered by the users;
a module for implementing an obfuscated secret transformation function ƒ_{Ts};
a module for providing data to one or several verification terminals; As explained above, these means are for example implemented through, for example secure, modules and/or components. They thus allow to ensure the security of the transactions carried out while guaranteeing a greater maintainability of the terminal.

In relation to FIG. 4, a simplified architecture of an intermediate transactional server (STi) capable of performing the processing of a transaction as presented previously is presented. An intermediate transactional server (STi) comprises a memory 41, a processing unit 42 equipped for example with a microprocessor, and driven by a computer program 43. Furthermore, the intermediate transactional server (STi) also comprises a communication module (CIE) being for example in the form of network components (WiFi, 3G/4G/5G, wired) which allow the intermediate transactional server (STi) to receive data (I) from entities (transactional terminal, decision server) connected to one or several communication networks and transmit processed data (T) to such entities.

Such an intermediate transactional server (STi) comprises, depending on the embodiments:
a module for determining a resolution of a touch screen of a terminal on which data must be entered;
a module for generating at least one data representative of a random variable (Dra, ParT), optionally depending on data (DRT) representative of a screen resolution of the touch screen of the electronic terminal (TermEt);
a module for transmitting said at least one data representative of a random variable (Dra, ParT) to the electronic terminal (TermEt), and
a module for transmitting, to a verification terminal, a table for decoding characters entered on said touch screen of the electronic terminal (TermEt).

A verification terminal capable of performing the processing of a transaction as presented previously, comprises a memory, a processing unit equipped for example with a microprocessor, and driven by a computer program. The touch screen terminal also comprises: a secure memory, which may optionally be merged with the memory, a secure processing unit equipped for example with a secure microprocessor for physical protection measuring (physical protection around the chip, by mesh, vias, etc. and protection on the data transmission interfaces), and driven by a computer program specifically dedicated to this secure processing unit, this computer program implementing all or part of the method for processing a transaction as previously described. The group composed of the secure processing unit of the secure memory and the dedicated computer program constitutes the secure portion of the touch screen terminal. In at least one embodiment, the present technique is implemented in the form of a set of programs installed in part or in whole on this secure portion of the transaction processing terminal. In at least one other embodiment, the present technique is implemented in the form of a dedicated component capable of processing data of the processing units and installed in part or in whole on the secure portion of the transaction processing terminal. Furthermore, the terminal also comprises a communication module being for example in the form of network components (WiFi, 3G/4G/5G, wired) which allow the terminal to receive data from entities connected to one or several communication networks and transmit processed data to such entities.

Such a verification terminal comprises, depending on the embodiments:
a module for receiving, from the electronic terminal (TermEt) comprising a touch screen, data representative of a random character (DrCa) obtained by the execution of a transformation function ƒ_{Ts}, data representative of coordinates (x,y) of pressing on the touch panel of the terminal, with means of said at least one data representative of a random variable (Dra, ParT);
a module for converting data representative of the random characters (DrCa) into characters actually entered, these means being in particular in the form of an inverse conversion table transmitted by the intermediate transactional server;
a module for validating the characters actually entered for a validation of a transaction, such as for example a payment transaction.

1. A method for processing data resulting from an entry on a touch screen, method implemented within an electronic terminal comprising a touch screen on which the data is entered, said electronic terminal comprising a module for connecting to an intermediate transactional server method wherein it comprises:
a step of receiving, from the intermediate transactional server to which the touch screen terminal is connected via a secure link, at least one data representative of a random variable;
a step of receiving, from a touch panel controller, data representative of coordinates of pressing on the touch panel of the terminal;
a step of transforming, via a transformation function ƒ_{Ts}, said data representative of coordinates of pressing on the touch panel of the terminal, by means of one of said at least one data representative of a random variable, delivering data representative of a random character such that different data representative of a random variable is used for each press on the touch panel of the terminal;
a step of transmitting, the data representative of a random character to a verification terminal.

2. The processing method according to claim 1, wherein the transformation step comprises the application of the following transformation function:
Cₛₐ=ƒ_{Ts}(R,x,y,a)
Cₛₐ is an obtained random character, which is transmitted in the form of the data representative of a random character,
R is a resolution of the screen;
x is the abscissa of the data representative of coordinates;
y is the ordinate of the data representative of coordinates;
a is a random variable inserted in the calculation, random variable obtained from said at least one data representative of a random variable.

3. The processing method according to claim 2 wherein the transformation function implements a random permutation, generated by the intermediate transactional server and received at least in part by the electronic terminal.

4. The processing method according to claim 2 wherein the transformation function implements a module function, the parameters of which have been randomly determined by the intermediate transactional server and received at least in part by the electronic terminal.

5. The processing method according to claim 1 wherein it further comprises, prior to the step of receiving said at least one data representative of a random variable, an optional step of transmitting, to the intermediate transactional server, data representative of a screen resolution of the touch screen of the electronic terminal.

6. The processing method according to claim 1 wherein it is implemented during the execution of an electronic payment transaction involving the entry, by a user, of a personal identification code on the touch screen of the electronic terminal.

7. An electronic terminal comprising a touch screen on which data is entered, said electronic terminal comprising a module for connecting to an intermediary transactional server, terminal wherein it comprises:
a module for receiving, from the intermediate transactional server to which the touch screen terminal is connected via a secure link, at least one data representative of a random variable;
a module for receiving, from a touch panel controller, data representative of coordinates of pressing on the touch panel of the terminal;
a module for transforming, implementing a transformation function ƒ_{Ts}, said data representative of coordinates of pressing on the touch panel of the terminal, by means of one of said at least one data representative of a random variable, the transformation module delivering data representative of a random character so that different data representative of a random variable is used for each press on the touch panel of the terminal;
a module for transmitting the data representative of a random character to the intermediate transactional server.

8. An intermediate transactional server, server of the type comprising a central unit, a memory and a module for receiving and transmitting data from a communication network, server comprising:
a module for determining data representative of a resolution of a touch screen of an electronic terminal on which data must be entered;
a module for generating at least one data representative of a random variable, optionally depending on the data representative of a screen resolution of the touch screen of the electronic terminal;
a module for transmitting said at least one data representative of a random variable to the electronic terminal, and
a module for transmitting, to a verification terminal, a table for decoding characters entered on said touch screen of the electronic terminal.

9. A terminal for verifying the validity of data entered on a touch screen of a touch screen terminal, terminal of the type comprising a central unit, a memory and a module for receiving and transmitting data from a communication network, verification terminal comprising:
a module for receiving, from an intermediate transactional server, a table for decoding characters entered on said touch screen of the electronic terminal;
a module for receiving, from the electronic terminal comprising a touch screen, data representative of a random character obtained by the execution of a transformation function ƒ_{Ts}, data representative of coordinates of pressing on the touch panel of the terminal, by means of at least one data representative of a random variable, so that different data representative of a random variable is used for each press on the touch panel of the electronic terminal;
a module for converting the data representative of the random characters into characters actually entered;
a module for validating the characters actually entered for a validation of a transaction.

10. A system for processing data resulting from an entry on a touch screen, system wherein it comprises:
an electronic terminal comprising a touch screen on which data is entered, said electronic terminal comprising a module for connecting to an intermediary transactional server, terminal wherein it comprises:
a module for receiving, from the intermediate transactional server to which the touch screen terminal is connected via a secure link, at least one data representative of a random variable;
a module for receiving, from a touch panel controller, data representative of coordinates of pressing on the touch panel of the terminal;
a module for transforming, implementing a transformation function ƒ_{Ts}, said data representative of coordinates of pressing on the touch panel of the terminal, by means of one of said at least one data representative of a random variable, the transformation module delivering data representative of a random character so that different data representative of a random variable is used for each press on the touch panel of the terminal;
a module for transmitting the data representative of a random character to the intermediate transactional server,
an intermediate transactional server, server of the type comprising a central unit, a memory and a module for receiving and transmitting data from a communication network, server comprising:
a module for determining data representative of a resolution of a touch screen of an electronic terminal on which data must be entered;
a module for generating at least one data representative of a random variable, optionally depending on the data representative of a screen resolution of the touch screen of the electronic terminal;
a module for transmitting said at least one data representative of a random variable to the electronic terminal, and
a module for transmitting, to a verification terminal, a table for decoding characters entered on said touch screen of the electronic terminal, and
a verification terminal according to claim 9.

11. A computer program product downloadable from a communication network and/or stored on a computer-readable medium and/or executable by a microprocessor, wherein it comprises program code instructions for the execution of a processing method according to claim 1, when executed on a computer.
